(19) United States
(12) Patent Application Publication
(10) Pub. No.: US 2026/0029739 A1
(43) Pub. Date: Jan. 29, 2026

(54) IMAGE FORMING SYSTEM, NON-TRANSITORY COMPUTER READABLE MEDIUM, AND METHOD

(71) Applicant: FUJIFILM Business Innovation Corp., Tokyo (JP)

(72) Inventor: Tomokazu KURITA, Kanagawa (JP)

(73) Assignee: FUJIFILM Business Innovation Corp., Tokyo (JP)

(21) Appl. No.: 19/023,773

(22) Filed: Jan. 16, 2025

(30) Foreign Application Priority Data
Jul. 26, 2024 (JP) 2024-120708

(51) Int. Cl. G03G 15/00

(52) U.S. Cl. CPC G03G 15/5029; G03G 15/6541; G03G 15/6585; G03G 2215/00751; G03G 2215/00835

(57) ABSTRACT

An image forming system includes a processor configured to obtain a type of printed material to be generated from a medium and control, in accordance with the obtained type of printed material, a mode of pressure-sealing toner, which demonstrates an adhesion function when deformed by pressure, at a time when the pressure-sealing toner is applied to the printed material.

### CROSS-REFERENCE TO RELATED APPLICATIONS

This application is based on and claims priority under 35 USC 119 from Japanese Patent Application No. 2024-120708 filed Jul. 26, 2024.

### BACKGROUND

### (i) Technical Field

The present disclosure relates to an image forming system, a non-transitory computer readable medium, and a method.

### (ii) Related Art

Pressure-sealed postcards, each of which is obtained by performing printing on a sheet of paper, folding the sheet in two or more, and sealing the folded sheet, are generally known. Pressure-sealed postcards are often used as direct mails (DMs) for sales promotion or other purposes. This is because the pressure-sealed postcards, which are folded sheets of paper, can increase the amount of information that can be included without increasing postage. In addition, since the inside of the pressure-sealed postcards can be seen only after unsealing, confidentiality can be assured. The pressure-sealed postcards, therefore, are suitable for, for example, notifying of personal information.

Pressure-sealing toners that demonstrate an adhesion function are available these years. When high pressure and heat are applied to pressure-sealing toner, pressure-responsive resin contained in the pressure-sealing toner reacts and functions like adhesive to adhere sheets of paper to each other. When pressure-sealing toner is used, a gluing step of applying an adhesive material to an inside surface to be adhered can be omitted.

### SUMMARY

It is convenient to be able to adjust adhesion for adhering a folded printed material in accordance with a type of printed material when the printed material is adhered using pressure-sealing toner.

Aspects of non-limiting embodiments of the present disclosure relate to adjustment of adhesion for a printed material in accordance with a type of printed material using pressure-sealing toner.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming system including a processor configured to: obtain a type of printed material to be generated from a medium; and control, in accordance with the obtained type of printed material, a mode of pressure-sealing toner, which demonstrates an adhesion function when deformed by pressure, at a time when the pressure-sealing toner is applied to the printed material.

### BRIEF DESCRIPTION OF THE DRAWINGS

An exemplary embodiment of the present disclosure will be described in detail based on the following figures, wherein:

FIG. 1 is a diagram illustrating an example of a block configuration of an image forming apparatus in an exemplary embodiment;

FIG. 2A is a diagram illustrating the number of lines for a non-confidential type, and FIG. 2B is a diagram illustrating the number of lines for a confidential type in the exemplary embodiment;

FIG. 3A is a diagram illustrating diameter of dots of pressure-sealing toner for the non-confidential type, and FIG. 3B is a diagram illustrating diameter of dots of the pressure sealing toner for the confidential type in the present exemplary embodiment;

FIG. 4A is a diagram illustrating thickness of the pressure-sealing toner for the non-confidential type, and FIG. 4B is a diagram illustrating thickness of the pressure-sealing toner for the confidential type in the present exemplary embodiment; and

FIG. 5A is a diagram illustrating positions of the pressure-sealing toner applied for the non-confidential type, and FIG. 5B is a diagram illustrating positions of the pressure-sealing toner applied for the confidential type in the present exemplary embodiment.

### DETAILED DESCRIPTION

An exemplary embodiment of the present disclosure will be described hereinafter on the basis of the drawings.

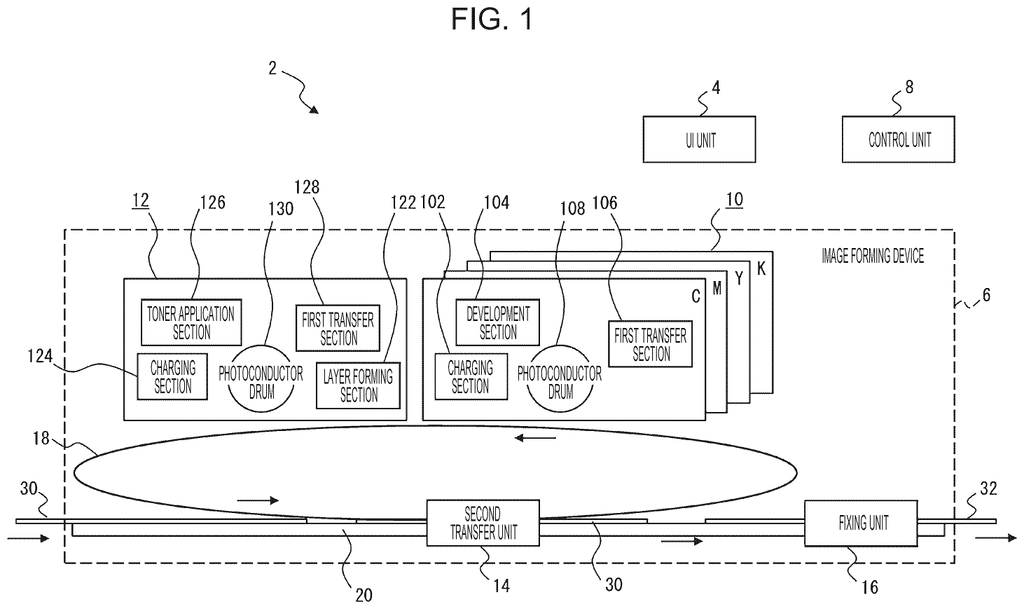

FIG. 1 is a diagram illustrating an example of a block configuration of an image forming apparatus 2 in the present exemplary embodiment. The image forming apparatus 2 in the present exemplary embodiment is an image forming system according to an exemplary embodiment of the present disclosure, and generates printed materials by forming images on a medium. A printed material processing system that processes a printed material into a pressure-sealed postcard, a pressure-sealed envelope, or another letter through cutting, folding, pressure sealing, and other steps is generally installed at a stage subsequent to the image forming apparatus 2.

The image forming apparatus 2 is a production color printer having a printing function and an apparatus with a built-in computer. The image forming apparatus 2, therefore, includes a central processing unit (CPU), a read-only memory (ROM), a random-access memory (RAM), a hard disk drive (HDD) as storage means, a network interface as communication means, and an operation panel as a user interface. Components other than those related to pressure-sealing toner, which will be described later, may be configured as before.

As illustrated in FIG. 1, the image forming apparatus 2 includes a user interface (UI) unit 4, an image forming device 6, and a control unit 8. Components that are not used for description of the present exemplary embodiment, including network means, for example, are omitted. A paper transport path, a paper tray, and the like related to printing are also omitted from the drawing.

The UI unit 4, which is achieved by an operation panel, receives instructions from a user and displays information. The image forming device 6 achieves the printing function of the image forming apparatus 2 and creates a printed material 32 by forming an image on a sheet of paper 30, which is a printing medium. The control unit 8 controls operation of each component included in the image forming apparatus 2. The control unit 8 may control operation of each component in accordance with an instruction from a server that is not illustrated.

The image forming device 6 includes image forming units 10, a pressure-sealing toner application unit 12, a second transfer unit 14, a fixing unit 16, an intermediate transfer belt 18, and a transport path 20, and forms an image on the sheet of paper 30 through a predetermined image forming process. The predetermined image forming process generally includes steps of exposure, development, transfer, fixing, cleaning, and elimination of static charge. In the present exemplary embodiment, too, an image is formed on the sheet of paper 30 through a basically similar process. FIG. 1 illustrates blocks corresponding to the charging step, the development step, the transfer step, and the fixing step of the image forming process, that is, charging sections 102, development sections 104, transfer units and a transfer section (first transfer sections 106 and the second transfer unit 14), and the fixing unit 16.

The image forming device 6 includes the image forming units 10 (i.e., image forming engines) corresponding to different colors. The colors are cyan (C), magenta (M), yellow (Y), and black (K). Toner cartridges corresponding to these colors are mounted on the image forming apparatus 2. The image forming units 10 each include a charging section 102, a development section 104, a first transfer section 106, and a photoconductor drum 108.

In the charging step, charging devices including charging rollers (corresponding to the charging sections 102) execute a charging function to charge the photoconductor drums 108. In the exposure step, exposure devices including lasers execute an exposure function to reduce potentials of parts of surfaces of the charged photoconductor drums 108 with which printing in the corresponding colors is performed on the sheet of paper 30. In the development step, development devices including magnetic rolls (corresponding to the development sections 104) execute a development function to apply toners of the corresponding colors to the parts of the surfaces of the photoconductor drums 108 where the potentials have been reduced. The transfer step includes first transfer performed by the first transfer sections 106 and second transfer performed by the second transfer unit 14. In the first transfer, transfer devices including transfer rolls (corresponding to the first transfer sections 106) execute a transfer function to transfer the toners of the corresponding colors applied to the photoconductor drums 108 onto the intermediate transfer belt 18. In the second transfer, a transfer device including a second transfer roll (corresponding to the second transfer unit 14) executes a transfer function to transfer the toners applied to the intermediate transfer belt 18 onto the sheet of paper 30 transported along the transport path 20. In the fixing step, the toners transferred onto the sheet of paper 30 are fixed when the sheet of paper 30 is transported to a nip between a heating roll and a pressure roll along the transport path 20.

The image forming units 10 sequentially transfer the toners of C, M, Y, and K onto the intermediate transfer belt 18 by performing the image forming process. As a result, the toners of the four colors overlap one another to form CMYK layers.

The image forming apparatus 2 in the present exemplary embodiment includes the pressure-sealing toner application unit 12 as a more special image forming engine separately from the general CMYK image forming engines. “Pressure-sealing toner” refers to special toner that achieves a sealing function when deformed by pressure. More specifically, the pressure-sealing toner is a colorless transparent toner in which pressure-responsive resin is finely dispersed, and only when high pressure is applied, the resin softens and achieves a function of adhering sheets of paper to each other. The four toner cartridges (not illustrated) filled with the C, M, Y, and K color toners (hereinafter collectively referred to as “color toners”) are mounted on the image forming apparatus 2, and the same applies to the pressure-sealing toner.

The pressure-sealing toner application unit 12 includes a layer forming section 122, a charging section 124, a toner application section 126, a first transfer section 128, and a photoconductor drum 130. The layer forming section 122 applies a pressure-sealing toner layer to the intermediate transfer belt 18 (i.e., the CMYK layers), onto which the color toners have been transferred, as a base layer for applying the pressure-sealing toner to the CMYK layers. The pressure-sealing toner layer is basically a colorless transparent special toner layer formed in accordance with size of the sheet of paper 30. The charging section 124 charges the photoconductor drum 130. The toner application section 126 applies the pressure-sealing toner to parts of the photoconductor drum 130 where potentials have been reduced. The first transfer section 128 transfers the pressure-sealing toner applied to the photoconductor drum 130 onto the intermediate transfer belt 18. Strictly speaking, since the pressure-sealing toner layer has been formed on the intermediate transfer belt 18 at a position at which the toners are transferred, the pressure-sealing toner is transferred onto the pressure-sealing toner layer.

The second transfer unit 14 then functions as a transfer device that collectively transfers the toners (including the pressure-sealing toner layer) transferred onto the intermediate transfer belt 18 onto the sheet of paper 30 with electric force. The fixing unit 16 functions as a fixing device that heats and pressurizes the toners transferred onto the sheet of paper 30 to fix the toners. The CMYK layers and the pressure-sealing toner layers are formed on the intermediate transfer belt 18, and the pressure-sealing toner is also applied. The transport path 20 is a path used until the sheet of paper 30 fed from a paper feed tray is discharged from the printed material processing system at the subsequent stage.

The image forming apparatus 2 generates a full-color printed material 32 by performing the image forming process with the above configuration. The pressure-sealing toner has been applied to the generated printed material 32 in addition to the color toners.

The components 4 to 8 of the image forming apparatus 2 are achieved as a result of coordinated action of a computer mounted on the image forming apparatus 2 and a program executable by a CPU mounted on the computer. The program used in the present exemplary embodiment can of course be provided using the communication means, but can also be stored in a computer readable storage medium such as a universal serial bus (USB) memory and provided. The program provided from the communication means or the storage medium is installed on the computer, and the CPU sequentially executes the program to achieve various types of processing. The present disclosure can be applied to a program and a program product.

As an example, the image forming system in the present exemplary embodiment is achieved by a single image forming apparatus 2 in the above description, the image forming system may be achieved by a plurality of apparatuses, instead.

Next, operations in the present exemplary embodiment will be described.

The image forming apparatus 2 may be the same as a general production color printer in terms of an image forming process in which color toners are used, except for the application of the pressure-sealing toner to the sheet of paper 30. That is, the control unit 8 receives an instruction from the server that is not illustrated, and forms the CMYK layers by controlling operation of the image forming units 10 in accordance with the instruction. The control unit 8 in the present exemplary embodiment also controls operation of the pressure-sealing toner application unit 12 in accordance with an instruction from the server. In particular, in the present exemplary embodiment, the control unit 8 obtains, with respect to the application of the pressure-sealing toner to the printed material 32, a type of printed material 32 to be generated from the sheet of paper 30, and controls, in accordance with the obtained type of printed material 32, a mode of the pressure-sealing toner applied to the printed material 32. The control unit 8 may be separately provided for the color toners and the pressure-sealing toner.

In the present exemplary embodiment, a case will be described where two types of generated printed material 32, namely a confidential type, which is a first type of printed material 32, and a non-confidential type, which is a second type of printed material 32, are generated.

“Confidential” means a desire that a sealed letter be unsealed and read by a person to whom the letter is addressed, or treatment of the letter as such. The “confidential type” in the present exemplary embodiment is printed materials 32 to be treated confidentially, and refers to printed materials in general whose content should not be exposed to a third party for confidentiality purposes. When the confidential type is a DM, for example, accidental unsealing during delivery needs to be avoided. A “non-confidential type” in the present exemplary embodiment, on the other hand, is printed materials 32 other than the confidential type. The non-confidential type refers to printed materials in general that require less confidentiality than the confidential type. It is needless to say that even the non-confidential type should prevent an adhesive surface from peeling off, but a requirement level thereof need not be as high as that of the confidential type.

For this reason, the confidential type requires stronger adhesion than the non-confidential type in order to make an adhesive surface hard to peel off. As described later, the user specifies whether a printed material 32 is of the confidential type or the non-confidential type. The adhesive surface refers to a surface of a printed material 32 to which the pressure-sealing toner is applied.

In order to make an adhesive surface hard to peel off, the mode of the pressure-sealing toner applied to the printed material 32 is controlled in the present exemplary embodiment. The term “mode” usually refers to an appearance, a structure, or a state of an object, but in the present exemplary embodiment, the amount of pressure-sealing toner applied to the printed material 32 or positions of the pressure-sealing toner applied to the printed material 32 are controlled as the mode of the pressure-sealing toner. Adhesion of the adhesive surface can thus be adjusted.

As described above, the image forming apparatus 2 in the present exemplary embodiment applies the pressure-sealing toner to the pressure-sealing toner layer formed on the CMYK layers after forming the CMYK layers on the intermediate transfer belt 18 using the color toners. The control unit 8 controls, in accordance with the type of printed material 32, the amount of pressure-sealing toner applied by the pressure-sealing toner application unit 12 and the positions of the pressure-sealing toner.

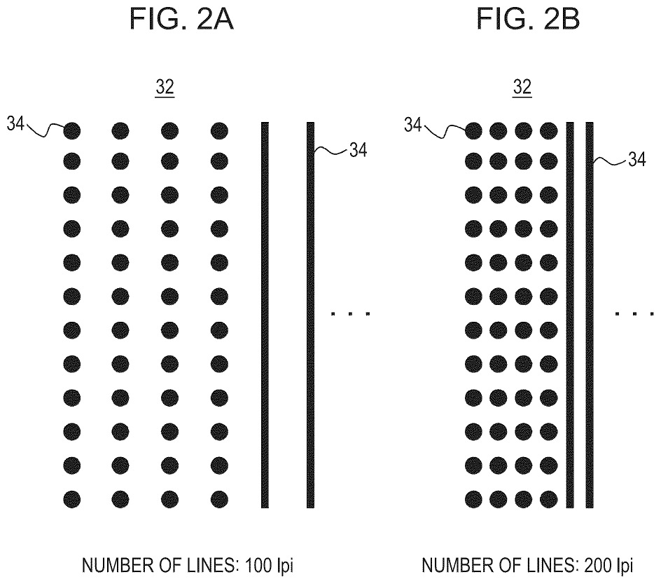

For example, the control unit 8 displays information on the UI unit 4, that is, the operation panel, such that the user can select whether the type of printed material 32 is the confidential type or the non-confidential type. The user selects the confidential type or the non-confidential type on the operation panel as the type of printed material 32. After the user selects the type of printed material 32, the control unit 8 forms the CMYK layers on the intermediate transfer belt 18 regardless of the selected type of printed material 32 by controlling the image forming units 10 in accordance with an instruction from the server as described above. The control unit 8 also receives an instruction according to the type selected by the user from the server and applies the pressure-sealing toner to the intermediate transfer belt 18 in a predetermined pattern by controlling the operation of the pressure-sealing toner application unit 12. The second transfer unit 14 and the fixing unit 16 at subsequent stages then operate to transfer the pressure-sealing toner onto a surface of the printed material 32 and fix the pressure-sealing toner. FIGS. 2A to 5B are diagrams illustrating not modes at a time when the pressure-sealing toner application unit 12 has applied the pressure-sealing toner 34 to the pressure-sealing toner layer but modes on the adhesive surface of the printed material 32.

FIGS. 2A, 3A, 4A and 5A schematically illustrate application patterns for the non-confidential type, and FIGS. 2B, 3B, 4B, and 5B schematically illustrate application patterns for the confidential type formed on the adhesive surface of the printed material 32.

FIGS. 2A and 2B are diagrams illustrating examples of a case where adhesion is adjusted with the amount of pressure-sealing toner 34 applied, and illustrate examples where area of application to the printed material 32 is adjusted as a method for adjusting adhesion. As readily seen, the mode of the pressure-sealing toner 34 is lines in FIGS. 2A and 2B. The number of lines is different between the non-confidential type and the confidential type. The “number of lines” is defined as the number of lines, per inch, of a screen used to form a dot pattern. FIGS. 2A and 2B illustrate four lines of dots in the dot pattern, and thick lines indicate application patterns of the pressure-sealing toner 34 to simplify the illustration.

FIGS. 2A and 2B illustrate examples where the pressure-sealing toner 34 is linearly applied with 100 lpi for the non-confidential type and with 200 lpi for the confidential type. A relatively large number of lines are used for the confidential type to increase the area of application to the printed material 32. According to the present exemplary embodiment, stronger adhesion required by the confidential type is thus achieved.

The values of the number of lines (100 lpi and 200 lpi) are examples, and the number of lines may be appropriately set in accordance with the type of printed material 32. Aside from the number of lines, the area of the pressure-sealing toner 34 applied to the printed material 32 may be generally increased by making length or thickness of lines for the confidential type greater than for the non-confidential type. Although FIGS. 2A and 2B illustrate examples where the pressure-sealing toner 34 is linearly applied as linear patterns, the lines are not limited to straight lines since it is only required that the area of the pressure-sealing toner 34 applied for the confidential type be larger than for the non-confidential type. For example, the lines may be curves, instead.

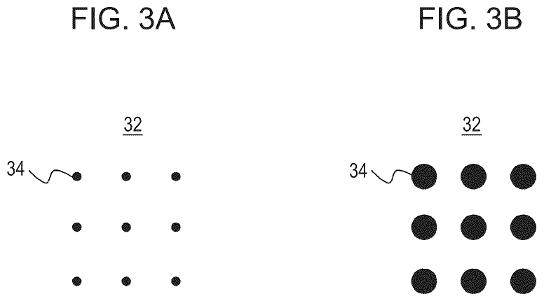

FIGS. 3A and 3B are diagrams illustrating other examples of the case where adhesion is adjusted with the amount of pressure-sealing toner 34 applied, and illustrate examples where the area of application to the printed material 32 is adjusted as the method for adjusting adhesion as in FIGS. 2A and 2B. As readily seen, the mode of the pressure-sealing toner 34 is dots in FIGS. 3A and 3B. Size of dots is different between the non-confidential type and the confidential type.

FIGS. 3A and 3B illustrate an example where, when the pressure-sealing toner 34 is applied in a grid pattern at constant intervals, the pressure-sealing toner 34 is applied with a relatively small diameter for the non-confidential type and with a relatively larger diameter for the confidential type. The area of application to the printed material 32 is thus increased by making the diameter of dots relatively large for the confidential type. According to the present exemplary embodiment, stronger adhesion required by the confidential type is thus achieved.

Although area of each dot is increased in FIGS. 3A and 3B, the number of dots applied for the confidential type may be larger than for the non-confidential type, instead. Alternatively, area of the pressure-sealing toner 34 applied to the printed material 32 may be increased by increasing the number of dots and the area of each dot.

Increasing the number of dots or the diameter of dots is equivalent to increasing the area of the pressure-sealing toner 34 occupying the adhesive surface of the pressure-sealing toner 34. In other words, the pressure-sealing toner 34 is applied to the adhesive surface of the printed material 32 for the confidential type with a higher density than for the non-confidential type. Although shapes of the dots are circles in FIGS. 3A and 3B, the shapes of dots need not be limited to circles.

FIGS. 2A to 3B illustrate examples where the number of lines or the size of dots are focused upon as a mode for increasing the area of the pressure-sealing toner 34 applied. Because it is only required in the present exemplary embodiment that the area of the pressure-sealing toner 34 applied be increased, lines or dots need not have the same shape as illustrated in FIGS. 2A to 3B, and various thicknesses and lengths of lines or various diameters of dots may be mixed, instead.

It is only required, as illustrated in FIGS. 2A to 3B, that the area of the pressure-sealing toner 34 applied to the printed material 32 for the confidential type be larger than for the non-confidential type. That is, even when the amount of pressure-sealing toner 34 applied from the pressure-sealing toner application unit 12 is the same between the confidential type and the non-confidential type, for example, the diameter of dots of the pressure-sealing toner 34 may be varied by controlling thickness of the pressure-sealing toner layer (e.g., increasing the thickness of the pressure-sealing toner layer for the confidential type). This also applies to the thickness of lines.

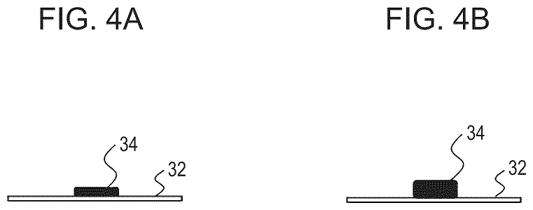

FIGS. 4A and 4B are diagrams illustrating other examples of the case where adhesion is adjusted with the amount of pressure-sealing toner 34 applied, and illustrate examples where the thickness of the pressure-sealing toner 34 applied to the printed material 32 is adjusted as the method for adjusting adhesion. Whereas FIGS. 2A to 3B assume that the thickness of the pressure-sealing toner 34 applied is the same between the confidential type and the non-confidential type, the thickness of the pressure-sealing toner 34 is different between the non-confidential type and the confidential type in FIGS. 4A and 4B. The area of the pressure-sealing toner 34 applied to the printed material 32 is assumed to be the same between the non-confidential type and the confidential type. The thickness can be varied, for example, by controlling the number of times that the same amount of pressure-sealing toner 34 is applied, that is, the amount of pressure-sealing toner 34 accumulated, at the same positions.

Unlike the cases illustrated in FIGS. 2A to 3B, however, adhesion does not necessarily become stronger even if the amount of pressure-sealing toner 34 applied to the printed material 32 increases.

That is, if the pressure-sealing toner 34 is too thick, the pressure-sealing toner 34 might not sufficiently soften due to softness of the pressure-sealing toner layer when the printed material processing system at the subsequent stage applies pressure to the printed material 32 folded in two or the like for pressure sealing, and as a result, expected adhesion might not be achieved. If the pressure-sealing toner 34 is too thin, on the other hand, the amount of pressure-sealing toner 34 applied might be insufficient, and an adhesion function of the pressure-sealing toner 34 might not be fully demonstrated.

When the thickness of the pressure-sealing toner 34 is expressed as “density” and a maximum possible thickness of the pressure-sealing toner 34 after an end of the fixing step (i.e., after the printed material 32 is generated) is defined as 100% (i.e., density=100%), adhesion is insufficient for the confidential type if the density is less than 60% (i.e., too thin). The amount of pressure-sealing toner 34 applied, therefore, needs to be increased, that is, the thickness of the pressure-sealing toner 34 needs to be increased. If the density exceeds 80% (i.e., too thick), on the other hand, adhesion is insufficient for the confidential type.

For this reason, a thickness within a range where expected adhesion can be demonstrated, that is, a thickness with a density of 60% to 80%, is achieved for the confidential type. For the non-confidential type, which does not require adhesion as strong as the confidential type, a thickness with a density of less than 60% or more than 80% is achieved. According to the present exemplary embodiment, stronger adhesion required by the confidential type is thus achieved.

Although the area of the pressure-sealing toner 34 applied for the confidential type is the same as for the non-confidential type here, the modes of the pressure-sealing toner 34 in FIGS. 2A to 3B, where the area of application is varied, may be also be combined. That is, even though there is an exception in the present exemplary embodiment that the pressure-sealing toner 34 applied to the printed material 32 needs to be prevented from becoming too thick, strong adhesion suitable for the confidential type can be achieved by making volume, which is based on area and thickness, of the pressure-sealing toner 34 applied to the printed material 32 larger than for the non-confidential type, that is, by increasing the amount of pressure-sealing toner 34 applied.

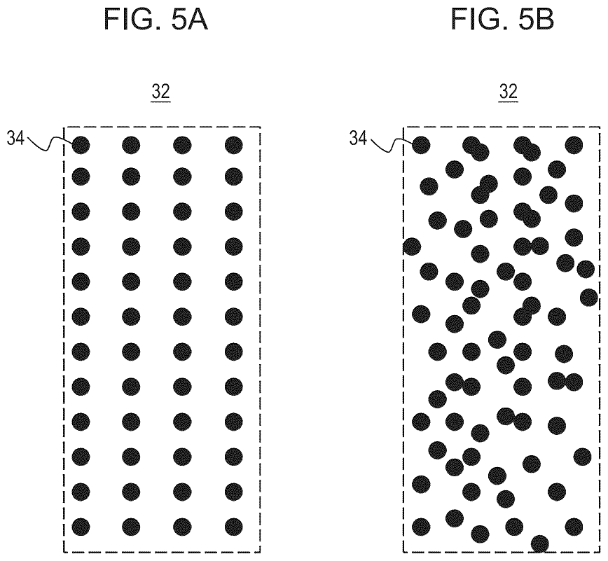

FIGS. 5A and 5B, on the other hand, are diagrams illustrating examples of a case where adhesion is adjusted with positions of the pressure-sealing toner 34 at a time when the pressure-sealing toner 34 is applied to the printed material 32, and illustrate examples where regularity in the positions of the pressure-sealing toner 34 applied to the printed material 32 is adjusted as the method for adjusting adhesion. As readily seen, in FIGS. 5A and 5B, the pressure-sealing toner 34 is applied to the printed material 32 for the confidential type with less regularity in position than for the non-confidential type. That is, it is conventionally known that adhesion becomes stronger with less regularity. On the basis of this knowledge, in the present exemplary embodiment, the pressure-sealing toner 34 is arranged for the confidential type with less regularity than for the non-confidential type as illustrated in FIGS. 5A and 5B to achieve stronger adhesion required by the confidential type.

As described above, in the present exemplary embodiment, the mode of the pressure-sealing toner applied to a printed material can be controlled in accordance with a type of printed material. As a result, stronger adhesion than for the non-confidential type required by the confidential type can be achieved.

Although the user specifies whether the type of printed material is the confidential type or the non-confidential type in the present exemplary embodiment, the user need not necessarily specify the type of printed material. For example, whether the type of printed material is the confidential type may be automatically determined and obtained by analyzing information to be printed on a sheet of paper, that is, for example, presence or absence of a name and an address of a person, presence or absence of words or phrases that can evoke a sense of confidentiality, and the like, instead.

Although there are two types of printed material, namely the confidential type and the non-confidential type, depending on information to be printed in the above example, three or more types of printed material may be provided on the basis of another index, instead, and pressure-sealing toner may be applied in modes according to the different types, instead.

The type of printed material is not limited to information to be included in a printed material and the like, and two or more types may be provided in accordance with a type of paper, that is, for example, characteristics of the printing medium including thickness and material.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))

An image forming system including:

a processor configured to:
obtain a type of printed material to be generated from a medium; and
control, in accordance with the obtained type of printed material, a mode of pressure-sealing toner, which demonstrates an adhesion function when deformed by pressure, at a time when the pressure-sealing toner is applied to the printed material.
   (((2)))

The image forming system according to (((1))),
in which the processor is configured to perform, when controlling the mode of the pressure-sealing toner with an amount of pressure-sealing toner applied, control such that the amount of pressure-sealing toner applied to a printed material of a first type becomes larger than the amount of pressure-sealing toner applied to a printed material of a second type, which does not require adhesion as strong as the printed material of the first type.
   (((3)))

The image forming system according to (((2))),
in which the processor is configured to control adhesion for the printed material by adjusting area over which the pressure-sealing toner adheres to the printed material.
   (((4)))

The image forming system according to (((2))) or (((3))),
in which the processor is configured to make, when the mode of the pressure-sealing toner is lines, a number of lines for the printed material of the first type larger than for the printed material of the second type.
   (((5)))

The image forming system according to (((2))) or (((3))),
in which the processor is configured to make, when the mode of the pressure-sealing toner is dots, a number of dots or area of dots for the printed material of the first type larger than for the printed material of the second type.
   (((6)))

The image forming system according to any one of (((2))) to (((5))),
in which the processor is configured to control adhesion for the printed material by adjusting thickness of the pressure-sealing toner at a time when the pressure-sealing toner is applied to the printed material.
   (((7)))

The image forming system according to (((1))),
in which the processor is configured to control the mode of the pressure-sealing toner with positions of the pressure-sealing toner applied to the printed material.
   (((8)))

The image forming system according to (((7))),
in which the processor is configured to apply the pressure-sealing toner to the printed material of the first type with less regularity in position than for the printed material of the second type, which does not require adhesion as strong as the printed material of the first type.
   (((9)))

The image forming system according to any one of (((1))) to (((8))),
in which the printed material of the first type is a printed material of a confidential type, and
in which the printed material of the second type is a printed material of a type other than the confidential type.
   (((10)))

A program causing a computer to execute a process including:
obtaining a type of printed material to be generated from a medium; and
controlling, in accordance with the obtained type of printed material, a mode of pressure-sealing toner, which demonstrates an adhesion function when deformed by pressure, at a time when the pressure-sealing toner is applied to the printed material.

What is claimed is:

1. An image forming system comprising:
a processor configured to:
obtain a type of printed material to be generated from a medium; and
control, in accordance with the obtained type of printed material, a mode of pressure-sealing toner, which demonstrates an adhesion function when deformed by pressure, at a time when the pressure-sealing toner is applied to the printed material.

2. The image forming system according to claim 1,
wherein the processor is configured to perform, when controlling the mode of the pressure-sealing toner with an amount of pressure-sealing toner applied, control such that the amount of pressure-sealing toner applied to a printed material of a first type becomes larger than the amount of pressure-sealing toner applied to a printed material of a second type, which does not require adhesion as strong as the printed material of the first type.

3. The image forming system according to claim 2,
wherein the processor is configured to control adhesion for the printed material by adjusting area over which the pressure-sealing toner adheres to the printed material.

4. The image forming system according to claim 3,
wherein the processor is configured to make, when the mode of the pressure-sealing toner is lines, a number of lines for the printed material of the first type larger than for the printed material of the second type.

5. The image forming system according to claim 3,
wherein the processor is configured to make, when the mode of the pressure-sealing toner is dots, a number of dots or area of dots for the printed material of the first type larger than for the printed material of the second type.

6. The image forming system according to claim 2,
wherein the processor is configured to control adhesion for the printed material by adjusting thickness of the pressure-sealing toner at a time when the pressure-sealing toner is applied to the printed material.

7. The image forming system according to claim 1,
wherein the processor is configured to control the mode of the pressure-sealing toner with positions of the pressure-sealing toner applied to the printed material.

8. The image forming system according to claim 7,
wherein the processor is configured to apply the pressure-sealing toner to the printed material of the first type with less regularity in position than for the printed material of the second type, which does not require adhesion as strong as the printed material of the first type.

9. The image forming system according to claim 4,
wherein the printed material of the first type is a printed material of a confidential type, and
wherein the printed material of the second type is a printed material of a type other than the confidential type.

10. The image forming system according to claim 5,
wherein the printed material of the first type is a printed material of a confidential type, and
wherein the printed material of the second type is a printed material of a type other than the confidential type.

11. The image forming system according to claim 8,
wherein the printed material of the first type is a printed material of a confidential type, and
wherein the printed material of the second type is a printed material of a type other than the confidential type.

12. A non-transitory computer readable medium storing a program causing a computer to execute a process comprising:
obtaining a type of printed material to be generated from a medium; and
controlling, in accordance with the obtained type of printed material, a mode of pressure-sealing toner, which demonstrates an adhesion function when deformed by pressure, at a time when the pressure-sealing toner is applied to the printed material.

13. A method comprising:
obtaining a type of printed material to be generated from a medium; and
controlling, in accordance with the obtained type of printed material, a mode of pressure-sealing toner, which demonstrates an adhesion function when deformed by pressure, at a time when the pressure-sealing toner is applied to the printed material.
